(19) United States
(12) Patent Application Publication
(10) Pub. No.: US 2020/0251267 A1
(43) Pub. Date: Aug. 6, 2020

(54) SOLENOID INCLUDING A DISPLACEABLE FERROMAGNETIC MEMBER WITHIN AN AIR GAP

(71) Applicants: DENSO International America, Inc., Southfield, MI (US); DENSO CORPORATION

(72) Inventors: Michael OZIKA, Novi, MI (US); Daniel MCGRAIL, Southfield, MI (US)

(21) Appl. No.: 16/268,863

(22) Filed: Feb. 6, 2019

(51) Int. Cl. H01F 7/16; H01F 7/08; F16H 21/38

(52) U.S. Cl. CPC H01F 7/16; H01F 7/081; H01F 2007/085; H01F 2007/086; F16H 21/38

(57) ABSTRACT

A solenoid including a first magnetic core and a second magnetic core defining an air gap between. A displaceable ferromagnetic member is within the air gap. The ferromagnetic member magnetically connects the first magnetic core and the second magnetic core to create a magnetic flux path between them. This flux results in an increased pull between the first magnetic core and the second magnetic core. A solenoid coil surrounds at least one of the first magnetic core and the second magnetic core.

### FIELD

The present disclosure relates to a solenoid including a compressible or displaceable ferromagnetic member within the air gap.

### BACKGROUND

This section provides background information related to the present disclosure, which is not necessarily prior art.

Solenoids include an “air gap” (a break in the material) so that force will be generated to pull a plunger, and so the plunger has space to move. The gap naturally adds a large reluctance to the system. The air gap can be considered as having radial and axial components. Many conventional solenoid designs generate force on the plunger by utilizing only the radial air gap or only the axial air gap to provide the primary axial force on the plunger. Other designs use both the radial and axial air gaps to provide axial force on the plunger. The axial air gap is typically large as compared to the radial air gap because the plunger moves axially. This large axial air gap has a large reluctance (due to the air) and therefore decreases the overall efficiency of the magnetic circuit.

In many solenoid applications, it is desirable to maximize magnetic force, while minimizing the size of the solenoid. To achieve high force in a small package size, tolerances can be reduced, thus reducing air gaps that act as large magnetic resistances or reluctances. However, such a solution is typically cost prohibitive. Another potential solution is to use materials having very high magnetic permeability. But this is also costly. Moreover, there are limits to the amount of magnetic force that can be achieved by reducing tolerances and optimizing material. The present disclosure overcomes these issues in the art and provides for numerous advantages and unexpected results, as explained in detail herein and as one skilled in the art will recognize.

### SUMMARY

This section provides a general summary of the disclosure, and is not a comprehensive disclosure of its full scope or all of its features.

The present disclosure includes a solenoid having a first magnetic core and a second magnetic core defining an air gap between. A ferromagnetic member is within the air gap. The ferromagnetic member magnetically connects the first magnetic core and the second magnetic core to create a magnetic flux path between them. This flux results in an increased pull between the two cores. A solenoid coil surrounds at least one of the first magnetic core and the second magnetic core.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional view of an exemplary solenoid in accordance with the present disclosure;

FIG. 2A is a cross-sectional view of an additional solenoid in accordance with the present disclosure;

FIG. 2B illustrates area 2B of FIG. 2A;

FIG. 2C is a cross-sectional view of the solenoid of FIG. 2A modified such that a spring sits in a cut out ring of a stator core;

FIG. 3 illustrates an exemplary reciprocating electric motor in accordance with the present disclosure;

FIG. 4A illustrates an exemplary ferromagnetic member in accordance with the present disclosure in the form of a compression spring;

FIG. 4B illustrates an exemplary ferromagnetic member in accordance with the present disclosure in the form of a helical spring;

FIG. 4C illustrates an exemplary ferromagnetic member in accordance with the present disclosure in the form of a flanged compression spring;

FIG. 4D illustrates an exemplary ferromagnetic member in accordance with the present disclosure in the form of a Belleville washer;

FIG. 4E illustrates an exemplary ferromagnetic member in accordance with the present disclosure in the form of a wave washer;

FIG. 4F illustrates an exemplary ferromagnetic member in accordance with the present disclosure in the form of a multi-start spring (such as 2, 3, 4, etc. start springs), which is typically machined;

FIG. 5A illustrates an exemplary ferromagnetic member according to the present disclosure in an expanded position, the ferromagnetic member including a plurality of ferromagnetic rods extending between a pair of rings;

FIG. 5B illustrates the ferromagnetic member of FIG. 5A in a compressed position;

FIG. 6A is a cross-sectional view of an exemplary ferromagnetic member in accordance with the present disclosure including a plurality of ferromagnetic materials in a substrate, the ferromagnetic member in an expanded position; and

FIG. 6B illustrates the ferromagnetic member of FIG. 6A in a compressed position.

Corresponding reference numerals indicate corresponding parts throughout the several views of the drawings.

### DETAILED DESCRIPTION

Example embodiments will now be described more fully with reference to the accompanying drawings.

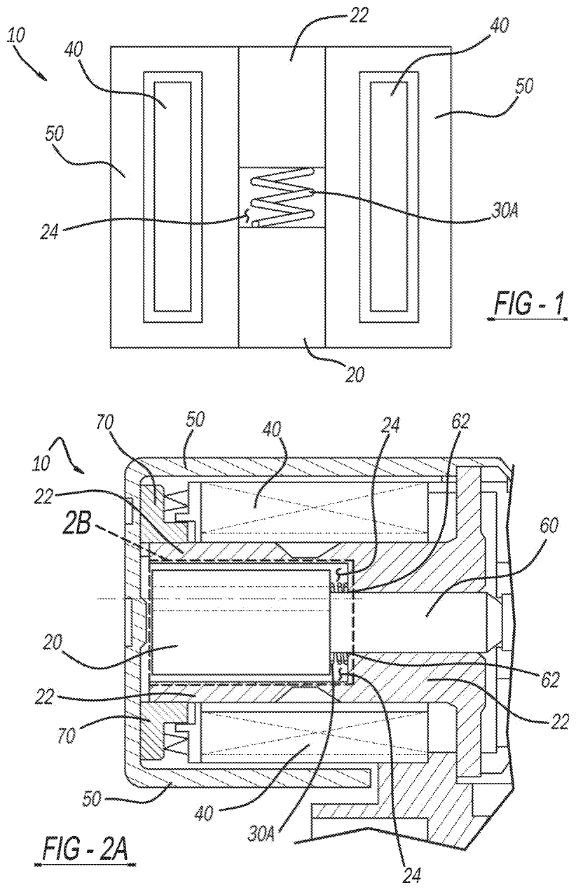

With initial reference to FIG. 1, a solenoid actuator in accordance with the present disclosure is illustrated at reference numeral 10. The solenoid 10 generally includes a first magnetic core 20, a second magnetic core 22, and an axial air gap 24 defined between the first magnetic core 20 and the second magnetic core 22. Depending on the particular application, the first magnetic core 20 may be a moving core, such as a plunger or an armature, for example. The second core 22 may be a stator. In other applications, the second magnetic core 22 may be a moving core, such that both the first magnetic core 20 and the second magnetic core 22 move. Surrounding the first magnetic core 20, the second magnetic core 22, and the ferromagnetic member 30A is a solenoid coil 40 and a yoke 50.

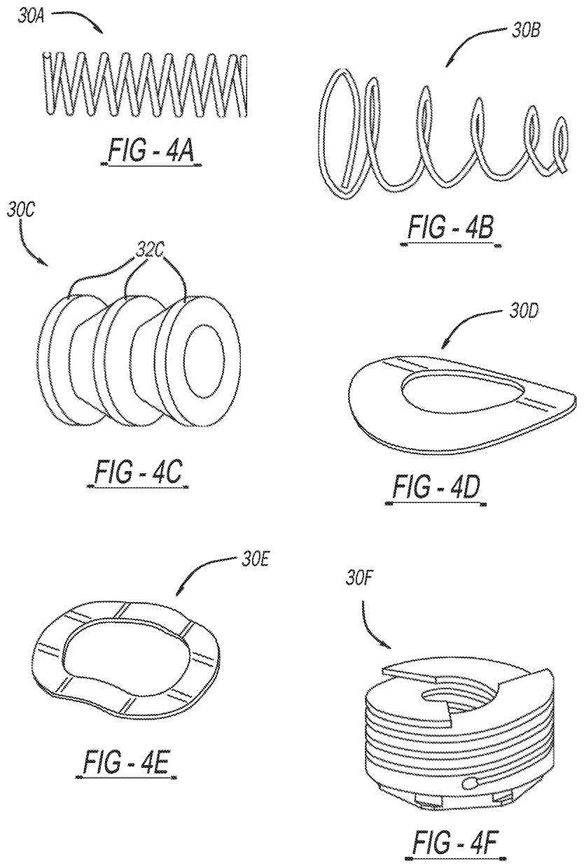

Seated within the axial air gap 24 is any suitable ferromagnetic member, such as the ferromagnetic member 30A illustrated in FIG. 1 as a compression spring. The ferromagnetic member may be any other suitable ferromagnetic member as well, as explained further herein and as illustrated in FIGS. 4A-7 at reference numbers 30A-30H, for example. The ferromagnetic member 30A (as well as the other exemplary ferromagnetic members 30B-30H described herein) magnetically connects the first magnetic core 20 and the second magnetic core 22 to lower the reluctance between them. This increases flux, which results in an increased force pulling the cores 20 and 22 towards each other. When the ferromagnetic member 30A is in the form of a spring, the spring may be a low carbon steel, iron, or other special magnetic material spring having a low spring constant (as close to zero as possible), for the purpose of increasing plunger force as opposed to a conventional spring that would oppose plunger movement.

The ferromagnetic member 30A (as well as any of the other ferromagnetic members 30B-30H set forth herein) has a low reluctance (such as lower than low carbon steel for example). The ferromagnetic member 30A (as well as any of the other ferromagnetic members 30B-30H set forth herein) is made of ferromagnetic material with exceptional magnetic properties (such as pure iron, amorphous steel, nanocrystalline steel, Mu Metal, Permalloy, and Permendur, for example) having a low spring constant.

The ferromagnetic member 30A creates a magnetic flux path by creating a direct connection between a top portion of the first magnetic core 20 and a bottom portion of the second magnetic core 22. This flux path results in an increased pull between the two cores 20 and 22. The ferromagnetic member 30A (as well as the other ferromagnetic members 30B-30H described herein) increases solenoid force by short circuiting the axial air gap 24 of the magnetic circuit between the first magnetic core 20 and the second magnetic core 22 with a (e.g. compressible) ferromagnetic medium. The ferromagnetic member 30A increases the axial force on the moving first magnetic core 20 (or both the first and second magnetic cores 20 and 22 when both cores 20 and 22 are movable) by reducing the reluctance in the axial air gap. The ferromagnetic member 30A does not have to directly touch the cores 20 and 22, as any of the components (first core 20, second core 22, ferromagnetic member 30A) may be treated with a thin, non-magnetic layer. Additionally, the ferromagnetic member 30A could be free-floating and never compress.

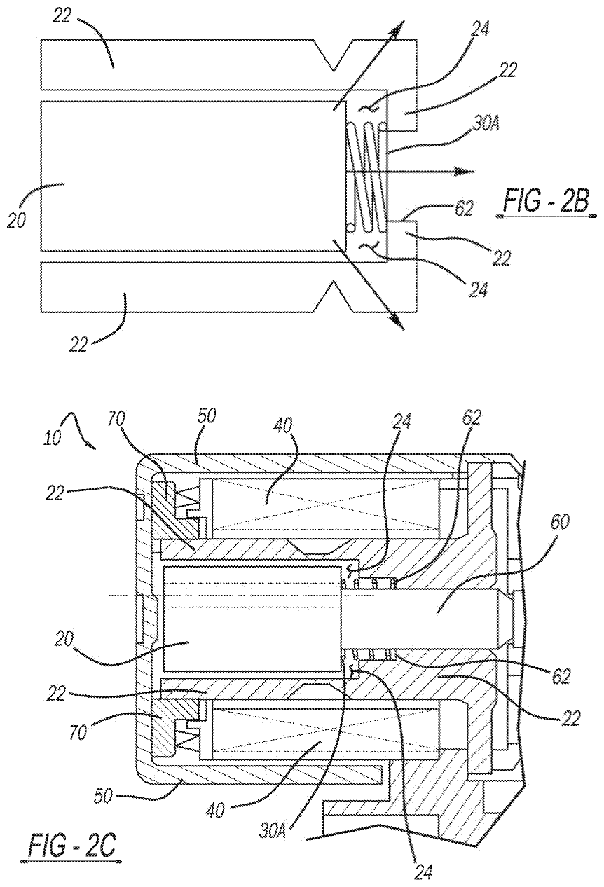

With additional reference to FIGS. 2A and 2B, the solenoid actuator 10 is illustrated in a more robust configuration. In the example of FIGS. 2A and 2B, the first magnetic core 20 is a plunger. The first magnetic core 20 is connected to, or is proximate to, a shaft 60. The shaft 60 extends through the ferromagnetic member 30A. A ring core 70 extends about the second magnetic core 22, and is arranged within the yoke 50. The ferromagnetic member 30A is connected to the first magnetic core 20 and the second magnetic core 22, which is a stator core. The shaft 60 extends through an aperture 62 defined by the second magnetic core 22, through the ferromagnetic member 30A, and into contact with the plunger in the form of the first magnetic core 20. With reference to FIG. 2C, in some applications the second magnetic core 22 may define a cut-out ring in which the ferromagnetic member 30A (which is in the form of a spring) sits.

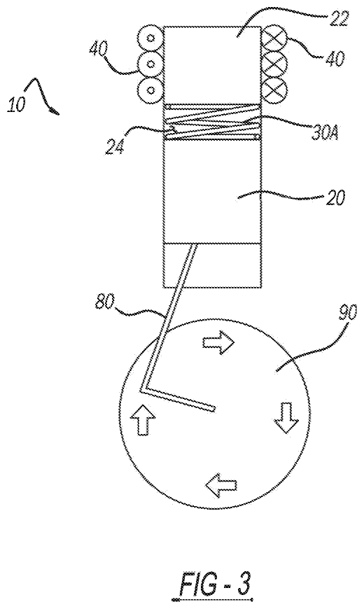

FIG. 3 illustrates the solenoid actuator 10 configured as a reciprocating electric motor. In the example of FIG. 3, the first magnetic core 20 is a moving core, and the second magnetic core 22 is a stator core. The ferromagnetic member 30A is seated in the axial air gap 24 defined between the first and second magnetic cores 20 and 22. The solenoid coil 40 is wrapped about the second magnetic core 22. A crankshaft 80 is connected to the first magnetic core 20 and a rotating flywheel 90 (the flywheel 90 is optional and need not be included). The flywheel 90 may be any suitable flywheel, such as any of the flywheels set forth in the following references, which are incorporated herein by reference in their entirety: U.S. Pub. No. 2014/0111035 A1 filed Oct. 24, 2012 and titled “Magnetically Actuated Reciprocating Motor And Process Using Reverse Magnetic Switching;” and U.S. Pub. No. 2012/0242174 A1 filed Mar. 27, 2011 and titled “Hybrid Electro-Magnetic Reciprocating Motor.”

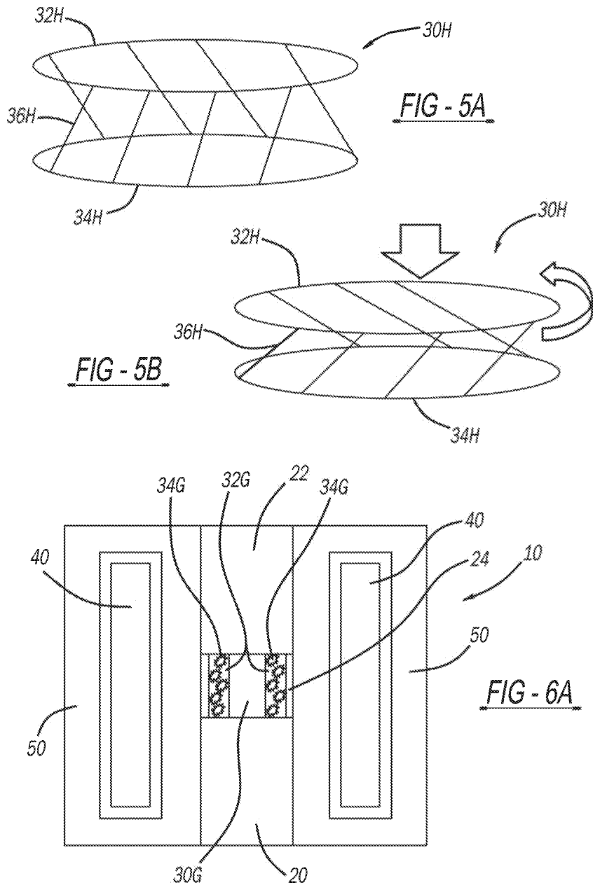

With reference to FIGS. 4A-7, various exemplary ferromagnetic members, which may be used in place of the ferromagnetic member 30A, will now be described. FIG. 4A illustrates the compression spring 30A discussed above. FIG. 4B illustrates the ferromagnetic member as an exemplary helical spring 30B. FIG. 4C illustrates the ferromagnetic member as an exemplary flanged compression spring 30C including a plurality of flanges 32C. FIG. 4D illustrates the ferromagnetic member as a Bellville washer 30D. FIG. 4E illustrates the ferromagnetic member as a wave washer 30E. FIG. 4F illustrates the ferromagnetic member in the form of machined springs 30F, such as 2, 3, 4, etc. start springs. FIG. 5A illustrates the ferromagnetic member as member 30H including a first ring 32H and a second ring 34H, which are connected by ferromagnetic rods 36H. As the ferromagnetic member 30H compresses, at least one of the first and second rings 32H and 34H rotate. If the second (bottom) ring 34H is held stationary, for example, as the ferromagnetic member 30H compresses the first ring 32H will rotate in a first direction, and the first ring 32H will rotate in a second direction that is opposite to the first direction when the ferromagnetic member 30H expands. If both the rings 32H and 34H are allowed to rotate, they will rotate in opposite directions as the ferromagnetic member 30H compresses and expands.

The shapes of the ferromagnetic materials 30A-30H advantageously maximize surface contact area and cross sectional area between the ferromagnetic materials 30A-30H and the first and second magnetic cores 20 and 22. This is in contrast to, for example, single start, round wire coil springs that have a small cross-sectional area that magnetically saturates quickly and limits flux flow.

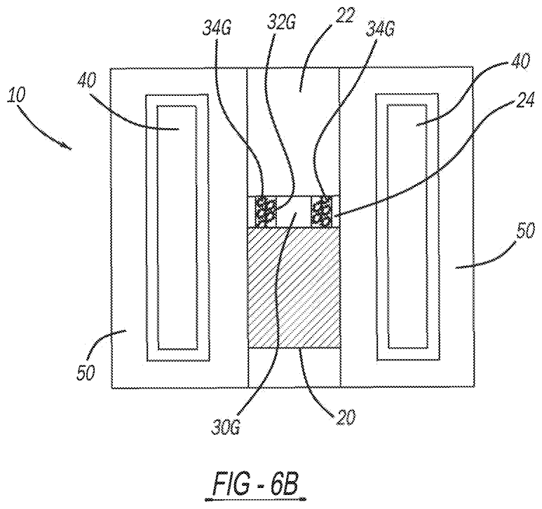

With reference to FIGS. 6A and 6B, another exemplary ferromagnetic member is illustrated at reference numeral 30G. The ferromagnetic member 30G includes a substrate 32G having a plurality of ferromagnetic particles 34G. The substrate 32G may be sponge-like or rubber-like embedded with the ferromagnetic particles 34G (e.g., rubber ferrite). Alternatively, the substrate 32G can be a metal mesh, such as compressible steel wool. FIG. 6A illustrates the ferromagnetic member 30G in an expanded position, and FIG. 6B illustrates the ferromagnetic member 30G in a compressed position as a result of the first magnetic core 20 moving towards the second magnetic core 22 thereby reducing the size of the axial air gap 24 therebetween.

The present disclosure thus advantageously increases solenoid force by short circuiting the axial air gap 24 of the magnetic circuit between the first magnetic core 20 and the second magnetic core 22 with a ferromagnetic member 30A-30H (many of which are compressible ferromagnetic members). This advantageously increases the axial force on the moving first magnetic core 20 (and the second magnetic core 22 when movable) by reducing the reluctance in the axial air gap 24. Although the solenoid 10 is illustrated as including a single ferromagnetic member 30A-30H, multiple ferromagnetic members may be arranged in parallel or series.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A solenoid comprising:
a first magnetic core and a second magnetic core defining an air gap between;
a ferromagnetic member within the air gap, the ferromagnetic member magnetically connects the first magnetic core and the second magnetic core to create a magnetic flux path therebetween; and
a solenoid coil surrounding at least one of the first magnetic core and the second magnetic core.

2. The solenoid of claim 1, wherein the first magnetic core is a moving magnetic core and the second magnetic core is a stator magnetic core.

3. The solenoid of claim 1, wherein the first magnetic core is a plunger and the second magnetic core is a stator magnetic core.

4. The solenoid of claim 1, wherein the first magnetic core is an armature and the second magnetic core is a stator magnetic core.

5. The solenoid of claim 1, wherein both the first magnetic core and the second magnetic core are movable.

6. The solenoid of claim 1, further comprising a movable shaft connected to the first magnetic core.

7. The solenoid of claim 1, further comprising a crankshaft connected to the first magnetic core such that movement of the first magnetic core translates the crankshaft.

8. The solenoid of claim 1, wherein the ferromagnetic member is a compression spring.

9. The solenoid of claim 1, wherein the ferromagnetic member is a helical spring.

10. The solenoid of claim 1, wherein the ferromagnetic member is a flanged compression spring.

11. The solenoid of claim 1, wherein the ferromagnetic member is a Belleville washer.

12. The solenoid of claim 1, wherein the ferromagnetic member is a wave washer.

13. The solenoid of claim 1, wherein the ferromagnetic member includes multi-start springs.

14. The solenoid of claim 1, wherein the ferromagnetic member includes a pair of rings connected by ferromagnetic rods.

15. The solenoid of claim 1, wherein the ferromagnetic member includes ferromagnetic particles within a compressible substrate.

16. The solenoid of claim 1, wherein the ferromagnetic member includes a spring contacting each one of the first magnetic core and the second magnetic core at a plurality of different points.

17. A solenoid comprising:
a first magnetic core and a second magnetic core defining an axial air gap between;
a ferromagnetic member within the axial air gap, the ferromagnetic member magnetically connects the first magnetic core and the second magnetic core to create a magnetic flux path between them, the flux results in an increased pull between the first magnetic core and the second magnetic core; and
a solenoid coil surrounding at least one of the first magnetic core and the second magnetic core;
wherein the ferromagnetic member includes one of a ferromagnetic spring, ferromagnetic washer, compressible substrate with ferromagnetic particles therein, and ferromagnetic rods extending between a pair of rings.

18. The solenoid of claim 17, wherein the first magnetic core is a moving magnetic core and the second magnetic core is a stator magnetic core.

19. The solenoid of claim 17, wherein both the first magnetic core and the second magnetic core are movable.

20. The solenoid of claim 17, further comprising a crankshaft connected to the first magnetic core and connected to a flywheel such that movement of the first magnetic core translates the crankshaft to rotate the flywheel.
